(19) United States
(12) Patent Application Publication
(10) Pub. No.: US 2013/0036205 A1
(43) Pub. Date: Feb. 7, 2013

(54) Metadata Processing Apparatus, Server, and Metadata Processing Method

(71) Applicants: Osamu Kaseno, Hamura-shi (JP); Masatoshi Murakami, Hamura-shi (JP); Hiroyuki Kamio, Tachikawa-shi (JP); Hiroshi Kazawa, Kumagaya-shi (JP); Mitsunori Omokawa, Ageo-shi (JP); Yuuki Nemoto, Kokubunji-shi (JP); Takayuki Tachikawa, Fukaya-shi (JP); Megumi Miyazaki, Kumagaya-shi (JP)

(72) Inventors: Osamu Kaseno, Hamura-shi (JP); Masatoshi Murakami, Hamura-shi (JP); Hiroyuki Kamio, Tachikawa-shi (JP); Hiroshi Kazawa, Kumagaya-shi (JP); Mitsunori Omokawa, Ageo-shi (JP); Yuuki Nemoto, Kokubunji-shi (JP); Takayuki Tachikawa, Fukaya-shi (JP); Megumi Miyazaki, Kumagaya-shi (JP)

(21) Appl. No.: 13/647,309

(22) Filed: Oct. 8, 2012

(30) Foreign Application Priority Data
Jul. 28, 2010 (JP) 2010-169667

(51) Int. Cl. G06F 15/16

(52) U.S. Cl. 709/219

(57) ABSTRACT

According to one embodiment, a metadata processing apparatus which communicates with a server that holds metadata, the metadata processing apparatus includes a metadata update module configured to update metadata pertaining to content, a transmission module configured to transmit, to the server, content identification data for identifying the content to which the metadata updated by the metadata update module pertains, a reception module configured to receive data transmitted from the server, a determination module configured to determine, on the basis of the data received from the server by the reception module, whether it is necessary to upload the metadata updated by the metadata update module, and a notification module configured to invoke notification that presses upload of the metadata updated by the metadata update module to the server when the determination module has determined that upload is necessary.

### CROSS-REFERENCE TO RELATED APPLICATIONS

This application is a continuation of U.S. patent application Ser. No. 13/046,287, now abandoned, which is based upon and claims the benefit of priority from Japanese Patent Application No. 2010-169667, filed Jul. 28, 2010; the entire contents of which are incorporated herein by reference.

### FIELD

Embodiments described herein relate generally to a metadata processing apparatus, a server, and a metadata processing method.

### BACKGROUND

An data processing apparatus capable of reproducing content, such as images or music, has been popularized. Data (metadata) on content to be processed by an data processing apparatus may be added to the content. A server which holds a plurality of pieces of metadata on content and delivers metadata to an data processing apparatus has been put to practical use.

The data processing apparatus lets the user know metadata on content, thereby enabling the user to be informed of the matter and the broadcast time of content. In addition, the data processing apparatus uploads metadata to a server, thereby enabling a plurality of users to share the metadata.

With a conventional method, the data processing apparatus requires the user to carry out a specific operation to upload metadata to a server. Therefore, this may cause the problem of failing to upload metadata to the server and therefore being unable to let a plurality of users share the metadata easily.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing for explaining a configuration of a server according to an embodiment.

FIG. 2 is an exemplary view showing for explaining a configuration of a client according to an embodiment.

FIG. 3 is an exemplary view showing for explaining a configuration of metadata stored in the server according to an embodiment.

FIG. 4 is an exemplary view showing for explaining metadata according to an embodiment.

FIG. 5 is an exemplary view showing for explaining the operation of the server and client according to an embodiment.

FIG. 6 is an exemplary view showing for explaining a dialogue display on the client according to an embodiment.

FIG. 7 is an exemplary view showing for explaining the operation of the server and client according to an embodiment.

### DETAILED DESCRIPTION

Various embodiments will be described hereinafter with reference to the accompanying drawings. In general, according to one embodiment, a metadata processing apparatus which communicates with a server that holds metadata, the metadata processing apparatus comprises: a metadata update module configured to update metadata pertaining to content; a transmission module configured to transmit, to the server, content identification data for identifying the content to which the metadata updated by the metadata update module pertains; a reception module configured to receive data transmitted from the server; a determination module configured to determine, on the basis of the data received from the server by the reception module, whether it is necessary to upload the metadata updated by the metadata update module; and a notification module configured to invoke notification that presses upload of the metadata updated by the metadata update module to the server when the determination module has determined that upload is necessary.

Hereinafter, referring to the accompanying drawings, a metadata processing apparatus, a server, and a metadata processing method according to an embodiment will be explained in detail.

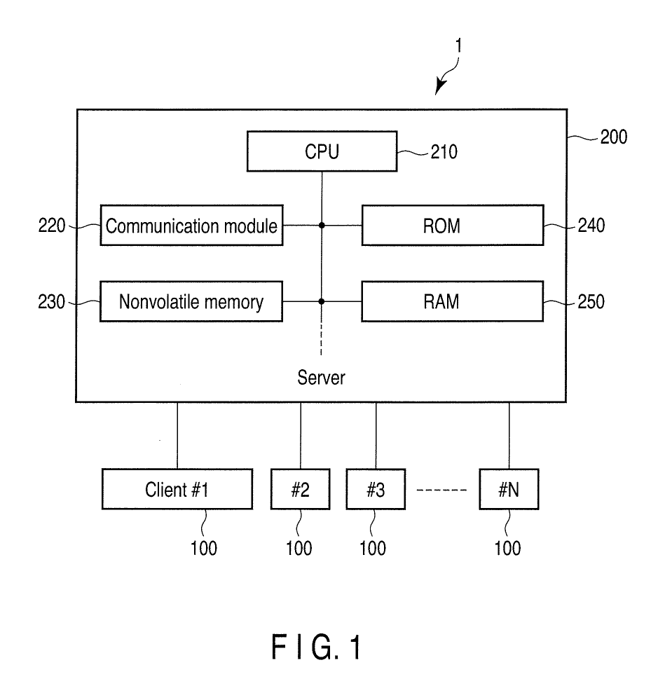

FIG. 1 shows an example of the configuration of a server 200 according to an embodiment. A metadata sharing system 1 enables metadata to be shared on a small-scale network at home or in a company or on the Internet. The metadata sharing system 1 comprises, for example, the server 200 and a plurality of clients 100.

Metadata is data pertaining to content. Metadata is for letting the user know a general outline of content. When content is a program supplied by a broadcast signal, metadata further has data for letting the user know the broadcast time and date of content. Metadata includes one or more of, for example, “broadcast time and date,” “channel,” “program (content) name,” “genre,” “author,” and other “detailed data” concerning content.

The server 200 comprises a CPU 210, a communication module 220, a nonvolatile memory 230, a ROM 240, and a RAM 250.

The CPU 210 includes an arithmetic element that performs various arithmetic operations and others. The CPU 210 realizes various functions by running a program stored in the nonvolatile memory 230, ROM 240, or the like.

The communication module 220 is configured to communicate with, for example, an external client 100. The communication module 220 includes, for example, a wired LAN port or a wireless LAN port. The communication module 220 can perform data communication with each of a plurality of clients 100 connected via a network.

The nonvolatile memory 230 stores various pieces of setting data, programs, metadata, and others in the server 200. In addition, the nonvolatile memory 230 stores metadata pertaining to programs (contents). The server 200 can transmit metadata stored in the nonvolatile memory 230 to the client 100 via a network.

The ROM 240 stores a program for controlling the server 200, programs for realizing various functions, and the like. The CPU 210 can activate the programs stored in the ROM 240 to control the operations of various parts.

The RAM 250 functions as a work memory of the CPU 210. Specifically, the RAM 250 stores the operation result of the CPU 210, data read by the CPU 210, and the like.

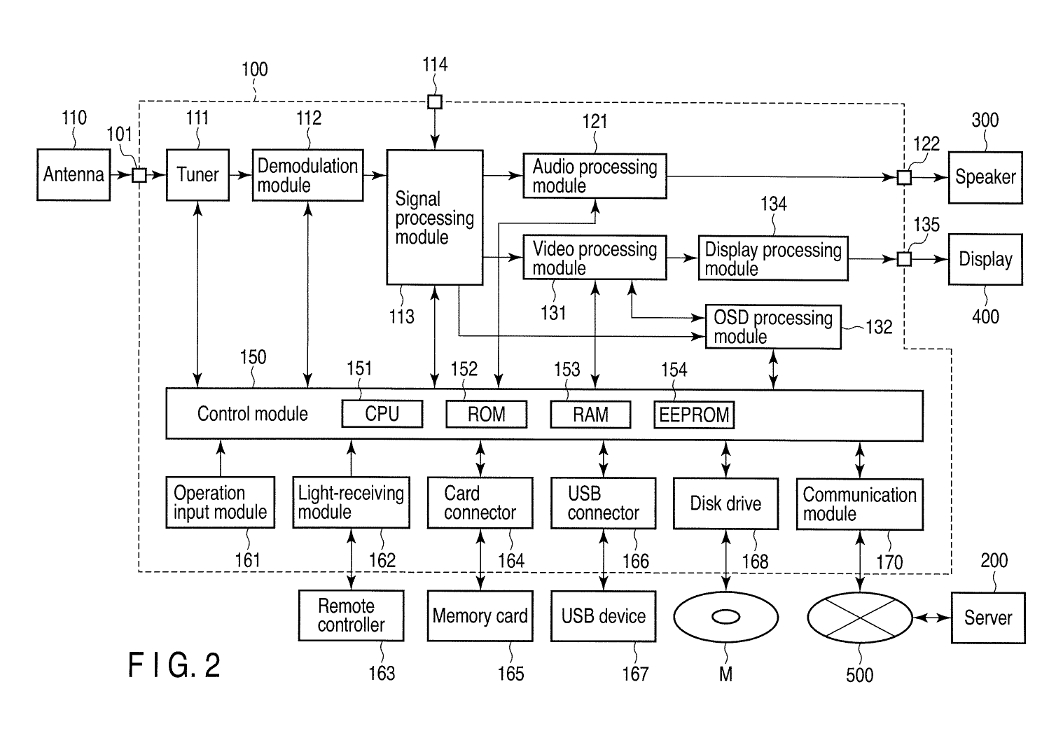

FIG. 2 shows an example of the configuration of a client 100 shown in FIG. 1. Explanation will be given on the assumption that the client 100 can acquire content from a broadcast signal, a storage medium, or a network.

The client 100 comprises an input terminal 101, a tuner 111, a demodulation module 112, a signal processing module 113, a communication interface 114, an audio processing module 121, an audio output terminal 122, a video processing module 131, an OSD processing module 132, a display processing module 134, a video output terminal 135, a control module 150, an operation input module 161, a light receiving module 162, a card connector 164, a USB connector 166, a disk drive 168, and a communication module 170.

The input terminal 101 is an input terminal to which, for example, a digital broadcast signal received by an antenna 110 is input. The antenna 110 receives, for example, a terrestrial digital broadcast signal, a broadcasting satellite (BS) digital broadcast signal, and/or a 110° communication satellite (CS) digital broadcast signal. That is, content, such as a program, supplied via a broadcast signal is input to the input terminal 101.

The input terminal 101 supplies the received digital broadcast signal to the tuner 111. The tuner 111 is a digital broadcast signal tuner. The tuner 111 tunes in to the digital broadcast signal supplied from the antenna 110. The tuner 111 transmits the tuned-in digital broadcast signal to the demodulation module 112.

The demodulation module 112 demodulates the received digital broadcast signal. The demodulation module 112 inputs the demodulated digital broadcast signal (content) to the signal processing module 113. That is, the antenna 110, tuner 111, and demodulation module 112 function as an input module to which content is input.

The communication interface 114 includes an interface capable of receiving content, such as High Definition Multimedia Interface (HDMI) (a registered trademark) terminal. The communication interface 114 receives content combined with a digital video signal, a digital audio signal, a data signal, and the like from another device. The communication interface 114 inputs the content received from another device to the signal processing module 113. That is, the communication interface 114 functions as an input module to which content is input.

The signal processing module 113 functions as a signal processing module that subjects input content to signal processing. The signal processing module 113 subjects content input from the demodulation module 112 to signal processing. For example, the signal processing module 113 separates content into a video signal, an audio signal, and other data signals. In addition, for example, the signal processing module 113 decodes each of the separated video signal, audio signal, and other data signals.

The signal processing module 113 supplies the decoded audio signal to the audio processing module 121. The signal processing module 113 supplies the decoded video signal to the video processing module 131. Moreover, the signal processing module 113 supplies the decoded data signal to the control module 150 and/or OSD processing module 133. For example, when a data signal of content includes metadata, the signal processing module 113 can supply metadata on content to the control module 150.

The signal processing module 113 selects and processes either content input from the communication interface 114 or content input from the input terminal 101.

The audio processing module 121 converts audio signal received from the signal processing module 113 into an audio signal in a format that can be reproduced by a speaker 300. The audio processing module 121 outputs the converted audio signal to the audio output terminal 122. The audio output terminal 122 outputs the supplied audio signal outside the apparatus. The speaker 300 connected to the audio output terminal 122 produces sound on the basis of the supplied audio signal.

The video processing module 131 converts a video signal received by the signal processing module 113 into a video signal in a format that can be reproduced by a display 400. The video processing module 131 generates a video signal for a screen to be reproduced by the display 400 on the basis of the video signal received from the signal processing module 113. The video processing module 131 inputs the generated video signal to a sequential display module 134.

The OSD processing module 132 performs On-Screen-Display (OSD) processing. The OSD processing module 132 generates a graphical user interface (GUI) screen and an OSD signal for superimposing subtitles, time, or other pieces of data on the screen on the basis of the data signal supplied from the signal processing module 113 and/or the control signal supplied from the control module 150. The OSD processing module 132 outputs the generated OSD signal to the video processing module 131. The video processing module 131 generates a video signal by superimposing the OSD signal supplied from the OSD processing module 132 on the screen.

The display processing module 134 subjects the received video signal to such processing as image quality adjustment, specifically adjustment of color, brightness, sharpness, or contrast, for example, under the control of the control module 150. The display processing module 134 outputs the image-quality-adjusted video signal to the video output terminal 135. The display 400 connected to the video output terminal 135 displays an image on the basis of the supplied video signal.

The display 400 is a display module which includes, for example, a liquid-crystal display device, an organic EL display, or a display device capable of displaying an image according to a video signal. The display 400 displays an image on the basis of the supplied video signal.

The client 100 may be configured to include the display 400 in place of the video output terminal 135. In addition, the client 100 may be configured to include the speaker 300 in place of the audio output terminal 122.

The control module 150 functions as a control module that controls various parts of the client 100. The control module 150 comprises a CPU 151, a ROM 152, a RAM 153, and an EEPROM 154. The control module 150 carries out various processes on the basis of a operation signal supplied from either the operation input module 161 or light-receiving module 162.

The CPU 151 includes arithmetic elements that perform various arithmetic operations. The CPU 151 runs a program stored in the ROM 152, EEPROM 154, or the like, thereby realizing various functions.

The ROM 152 stores a program for controlling the client 100 and a program for realizing various functions. The CPU 151 activates the program stored in the ROM 152 on the basis of the operation signal supplied from either the operation input module 161 or light receiving module 162. As a result, the control module 150 controls the operations of various parts.

The RAM 153 functions as a work memory of the CPU 151. Specifically, the RAM 153 stores the operation result of the CPU 151, data read by the CPU 151, and the like.

The EEPROM 154 is a nonvolatile memory that stores various pieces of setting data, programs, and others.

The operation input module 161 is an input module that includes, for example, operation keys, a keyboard, a mouse, and a touch pad or another input device capable of generating an operation signal according to an operation input. For example, the operation input module 161 generates an operation signal according to an operation input. The operation input module 161 supplies a generated operation signal to the control module 150.

The touch pad includes an electrostatic sensor, a thermo-sensor, or a device that generates position data on the basis of another method. When the client 100 includes a display 400, the operation input module 161 may be configured to include a touch panel formed integrally with the display 400.

The light receiving module 162 includes, for example, a sensor that receives an operation signal transmitted from the remote controller 163. The light receiving module 162 supplies the received operation signal to the control module 150. The remote controller 163 generates an operation signal on the basis of the operation input from the user. For example, the remote controller 163 transmits the generated operation signal to the light receiving module 162 via infrared communication. The light receiving module 162 and remote controller 163 may be configured to transmit and receive an operation signal via another wireless communication, such as radio waves.

The card connector 164 is an interface for communicating with, for example, a memory card 165. When the memory card 165 stores content, the card connector 164 reads content from the memory card 165 and supplies the read content to the control module 150.

The USB connector 166 is an interface for communicating with a USB device 167. The USB connector 166 supplies a signal from the USB device 167 to the control module 150.

For example, when the USB device 167 is an operation input device, such as a keyboard, the USB connector 166 receives an operation signal from the USB device 167. The USB connector 166 supplies the received operation signal to the control module 150. In this case, the control module 150 carries out various processes on the basis of the operation signal supplied from the USB connector 166.

In addition, for example, when the USB device 167 is a storage device that stores content, the USB connector 166 can acquire content from the USB device 167. The USB connector 166 supplies the acquired content to the control module 150.

A disk drive 168 includes a drive in which, for example, a compact disk (CD), a digital versatile disk (DVD), a Blu-ray disc (BD), or another optical disk M capable of storing moving-image content data can be installed. The disk drive 168 reads content from the installed optical disk M and supplies the read content to the control module 150.

The communication module 170 is an interface that connects with a small-scale network at home or in a company or with such a network 500 as the Internet and communicates with a device on the network 500. The communication module 170 includes, for example, a wired LAN port or a wireless LAN port. The communication module 170 can connect with the server 200 via a network to communicate with the server 200.

When the client 100 is connected to a network via an interface, the client 100 can acquire content on the network and reproduce the content.

Moreover, the client 100 may include a storage device, such as a hard disk (HDD), a solid-state disk (SSD), or a semiconductor memory. When the storage device stores content, the client 100 can read content stored in the storage device and reproduce the content. In addition, the client 100 can store content to be input to the signal processing module 133 into the storage device.

The client 100 includes a power supply module (not shown). The power supply module supplies electric power to various parts of the client 100. For example, the power supply module converts electric power supplied via an AC adapter or the like and supplies the converted power to various parts. The power supply module may include a battery. In this case, the power supply module charges the battery with electric power supplied via the AC adapter or the like. The power supply module supplies the electric power charged in the battery to various parts of the client 100.

When a broadcast signal is received and content is obtained, the client 100 can acquire metadata from the broadcast signal. For example, the client 100 acquires metadata from a data signal combined with content. In addition, for example, the client 100 acquires metadata from a packet in which metadata has been stored.

The packet in which metadata has been stored is supplied as a broadcast signal to the client 100. The packet in which metadata has been stored is, for example, a packet for displaying Electronic Program Guide (EPG) data. The client 100 can perform timer recording on the basis of the EPG data. In this case, metadata is used to search for a program.

When the user inputs a timer recording operation, the client 100 stores “broadcast time and date,” “channel,” “program name,” “genre,” “detailed data,” and others as metadata into the EEPROM 154.

A recording medium, such as an optical disk M, a memory card 165, or a USB device 167, may store metadata together with content. When content is acquired from a storage medium, such as the optical disk M, memory card 165, or USB device 167, in which content has been recorded, the client 100 acquires metadata stored together with content from the storage medium. The client 100 stores the acquired metadata into the EEPROM 154.

When content is acquired via the network 500, the client 100 acquires metadata from the network 500. The client 100 stores the acquired metadata into the EEPROM 154.

Furthermore, the client 100 transmits data that identifies content (content identification data) to the server 200 via the network 500. When receiving content identification data from the client 100, the server 200 reads metadata pertaining to content specified by the content identification data from the nonvolatile memory 230. The server 200 transmits the read metadata to the client 100.

That is, the client 100 can acquire metadata about content from the server 200. The client 100 stores the acquired metadata into the EEPROM 154.

The control module 150 and OSD processing module 132 can generate an OSD signal for displaying metadata on the display 400 by carrying out an OSD process on the basis of the metadata stored in the EEPROM 154. The video processing module 131 can display metadata on the screen by superimposing the OSD signal supplied from the OSD processing module 132 on a video signal. This enables the client 100 to provide the user with metadata about content.

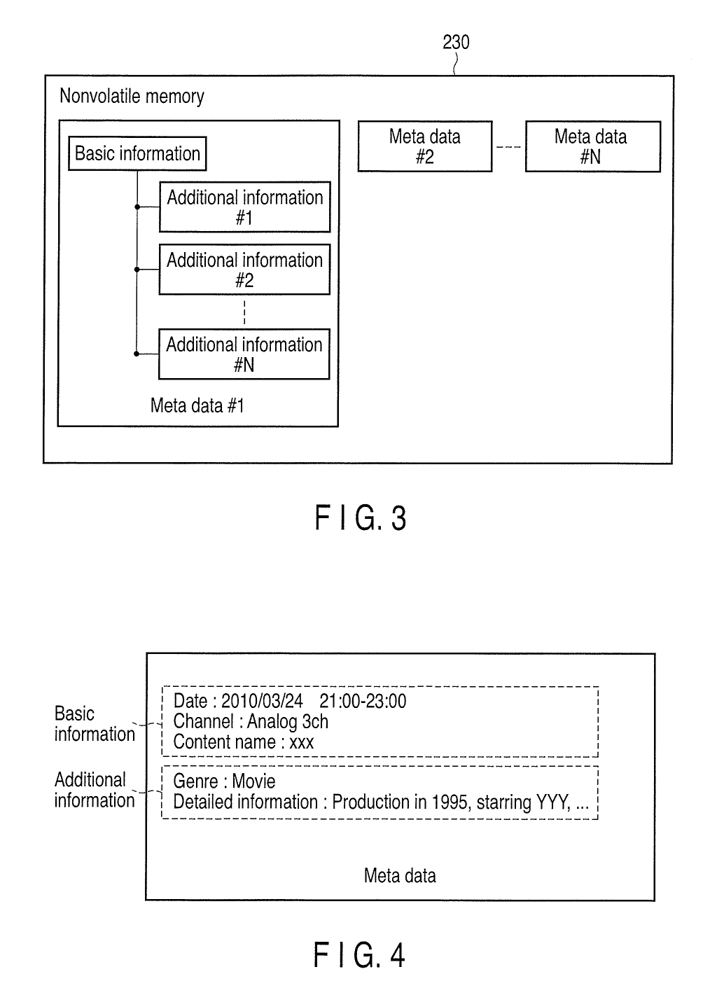

FIG. 3 shows an example of the configuration of metadata stored in the server 200 shown in FIG. 1. The nonvolatile memory 230 of the server 200 holds a plurality of pieces of metadata for each content.

As describe above, metadata has data that lets the user know a general outline of content. For example, metadata has one piece of basic data and at least one piece of additional data. The server 200 holds a plurality of pieces of metadata using the basic data as an index for each content.

FIG. 4 shows an example of metadata.

The basic data corresponds to content identification data. For example, the basic data includes the “broadcast time and date,” “channel,” “content name,” and others of content.

The additional data is data for letting the user know the matter of content. For example, additional data includes the “genre,” “detailed data,” and others of content. The detailed data includes the following pieces of data: for example, the author of content, the creation date of content, an outline of content, and others.

However, the contents of metadata acquired by the client 100 may not be sufficient to the user. To complement this, the user may edit the contents of metadata.

The additional data is data that the client 100 can edit. When a specific operation input is carried out on the operation input module 161 or light receiving module 162, the client 100 edits the metadata stored in the EEPROM 154. On the basis of an operation signal supplied from the operation input module 161 or light receiving module 162, the client 100 edits the contents of the additional data and stores the resulting data into the EEPROM 154.

As a result, the client 100 can change or add additional data according to a user operation input. Specifically, the client 100 enables the genre and detailed data to be changed or the user's impression or review or the like to be added on the basis of a user operation input.

In addition, the client 100 can transfer (upload) metadata stored in the EEPROM 154 to the server 200 via the network 500.

The server 200 identifies content on the basis of the basic data in the metadata received from the client 100. In addition, the server 200 adds additional data of metadata to metadata pertaining to the identified content. This enables the server 200 to hold a plurality of pieces of additional data pertaining to one content.

Furthermore, the client 100 can download from the server 200 additional data of metadata uploaded to the server 200 from another client 100. By the above process, the individual clients 100 connected to the server 200 can share metadata about content.

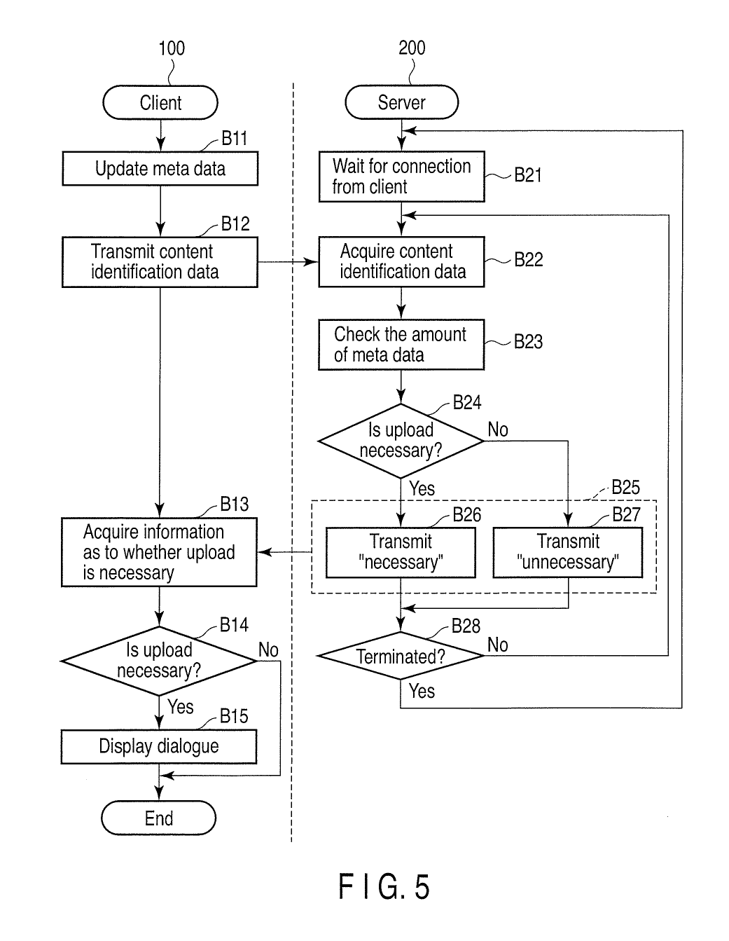

FIG. 5 shows an example of the operation of the server 200 and client 100 shown in FIG. 1.

In block B11, the client 100 confirms that metadata has been updated. For example, the client 100 determines that metadata has been updated, when metadata is newly stored in the EEPROM 154 or when metadata stored in the EEPROM 154 is edited.

When confirming that metadata has been updated, the client 100 generates content identification data on the basis of the updated metadata. In block B12, the client 100 transmits content identification data to the server 200.

As shown in block B21, the server 200 waits for connection from the client 100, when there is no connection from the client 100.

When the client 100 transmits content identification data, the server 200 receives content identification data in block B22. The server 200 identifies content on the basis of the received content identification data. For example, the server 200 extracts from the nonvolatile memory 230 metadata that has basic data coinciding with a content identify method received from the client 100.

In block B23, the server 200 checks the data amount of the extracted metadata. That is, the server 200 determines whether the number of pieces of additional data held by the extracted metadata is equal to or larger than a preset specific number. In addition, the server 200 determines whether the data amount of basic data is less than that of the content identification data received from the client 100.

Furthermore, in block B24, the server 200 determines whether it is necessary to cause the client 100 to upload metadata.

For example, if having determined that the number of pieces of additional data held by the extracted metadata is smaller than the preset specific number, the server 200 determines that upload is necessary. In addition, if having determined that the number of pieces of additional data held by the extracted metadata is equal to or larger than the preset specific number, the server 200 determines that upload is unnecessary.

Moreover, if having determined that the data amount of basic data is less than that of the content identification data received from the client 100, the server 200 determines that upload is necessary. Furthermore, if having determined that the data amount of basic data is equal to or greater than that of the content identification data received from the client 100, the server 200 determines that upload is unnecessary.

In block B25, the server 200 transmits data as to whether upload is necessary or unnecessary to the client 100.

Specifically, when having determined in block B24 that upload is necessary, the server 200, in block B26, transmits to the client 100 data indicating that the upload of metadata is necessary.

when having determined in block B24 that upload is unnecessary, the server 200, in block B27, transmits to the client 100 data indicating that the upload of metadata is unnecessary.

In block B28, the server 200 determines whether the connection is terminated according to the condition of communication with the client 100. When communication with the client 100 is terminated, the server 200 goes into a state where the server 200 waits for connection with the client 100 again. In addition, when the communication with the client 100 is not terminated, the server 200 goes into a state where the server 200 waits for content identification data to be transmitted from the client 100.

Furthermore, if having determined in block B23 that metadata about content specified by the content identification data has not been stored in the nonvolatile memory 230, the server 200 determines that the upload of metadata is necessary.

In block B13, the client 100 acquires from server 200 data as to whether the upload of metadata is necessary or not.

In block B14, on the basis of the acquired data as to whether upload is necessary or not, the client 100 determines whether the upload of metadata is necessary. That is, the client 100 determines whether the acquired data as to whether upload is necessary or not transmitted from the server 200 indicates necessary or unnecessary.

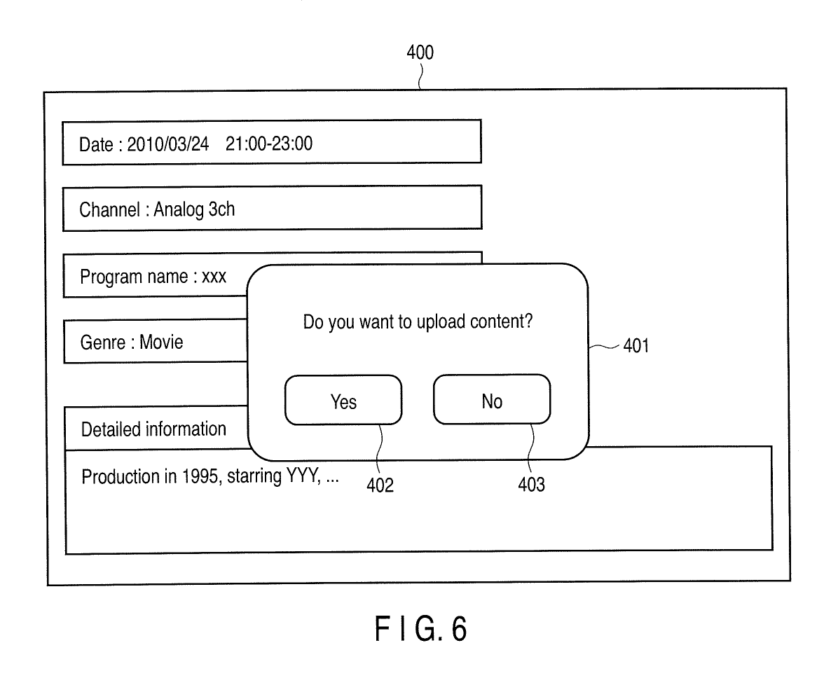

If the acquired data as to whether upload is necessary or not transmitted from the server is data indicating necessary, the client 100, in block B15, displays a dialogue that prompts the upload of metadata. The client 100 creates, for example, a dialogue screen as shown in FIG. 6. That is, when having determined that it is necessary to upload metadata, the client 100 give the user data that prompts the user to upload metadata to the server 200.

FIG. 6 shows a screen created by the client 100 shown in FIG. 1.

The control module 150 and OSD processing module 132 of the client 100 generate an OSD signal. The video processing module 131 superimposes the generated OSD signal on a video signal, thereby displaying a dialogue screen on the display 400.

The dialogue screen includes a character string that prompts the user to upload metadata, a button 402, and a button 403. The button 402 is a button for uploading metadata. When the operation of selecting button 402 is carried out, the client 100 uploads metadata to the server 200. That is, the client 100 uploads to the server 200 metadata determined to have been updated in block B11.

The button 403 is a button for not uploading metadata. When the operation of selecting the button 403 is carried out, the client 100 terminates the process without uploading metadata.

With the above configuration, it is possible to prompt the user to upload metadata. This enables the client 100 to prompt the user to determine whether to upload metadata, which makes it possible to upload metadata to the server 200. This makes it easier to upload metadata. Consequently, a metadata processing apparatus, a server, and a metadata processing method which are capable of sharing metadata easily can be provided.

Furthermore, the server 200 can prompt the user to upload metadata pertaining to content whose metadata is insufficient. This makes it possible to enrich metadata pertaining to content in the server 200.

While in the embodiment, the processes in block B23 and block B24 have been carried out by the server 200, the embodiment is not limited to this. The processes in block B23 and block B24 may be carried out by the client 100.

In this case, the client 100 transmits content identification data to the server 200. When content identification data is received from the client 100, the server 200 transmits to the client 100 data indicating the amount of metadata about content specified by the content identification data. On the basis of data indicating the amount of metadata transmitted from the server 200, the client 100 determines whether to show to the user a dialogue screen that prompts the user to upload metadata.

Moreover, while in the embodiment, it has been determined whether it is necessary to upload metadata when the metadata is updated, the embodiment is not limited to this. For instance, it may be determined whether it is necessary to upload metadata when the operation of finishing editing metadata is input. In this case, since a plurality of pieces of metadata can be edited consecutively, it is possible to make it easier for the user to operate.

Furthermore, first, it may be determined whether upload is necessary or not. Then, a dialogue may be displayed when metadata is updated.

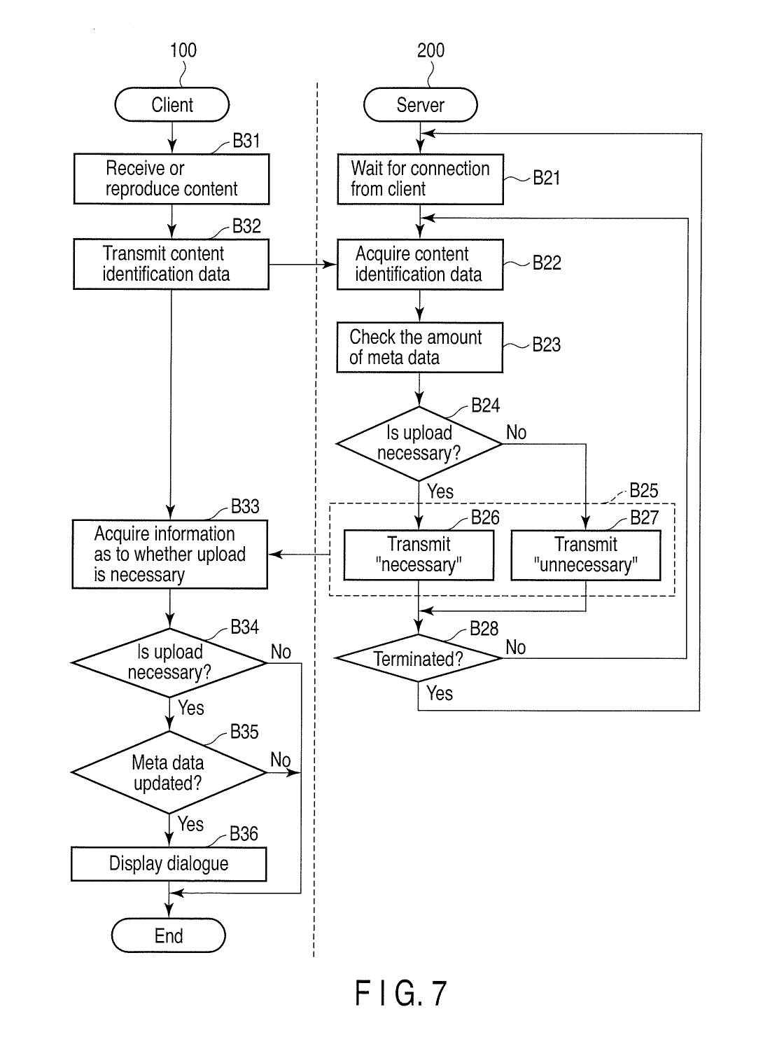

FIG. 7 shows another example of the operation of the server 200 and client 100 shown in FIG. 1. Since the operation of the server 200 is the same as in FIG. 5, a detailed explanation will be omitted.

In block B31, the client 100 confirms that content has been received or reproduced. That is, the client 100 confirms that a broadcast signal has been listened to, a broadcast signal has been recorded, content has been acquired from a network, content has been reproduced from a recording medium, or another similar operation has been carried out.

When confirming that content had been received or reproduced, the client 100 creates content identification data for identifying the content. In block B32, the client 100 transmits the content identification data to the server 200.

In block B33, the client 100 acquires from the server 200 data as to whether it is necessary to upload metadata.

In block B34, on the basis of the acquired data as to whether it is necessary to upload metadata, the client 100 determines whether it is necessary to upload metadata. That is, the client 100 determines whether the acquired data as to whether upload is necessary or not transmitted from the server indicates necessary or unnecessary.

If the acquired data as to whether upload is necessary or not transmitted from the server indicates necessary, the client 100 checks in block B35 whether metadata has been updated. If metadata has been newly stored in the EEPROM 154, if the metadata stored in the EEPROM 154 is edited, or if the metadata has been edited, the client 100 determines that the metadata has been updated. If having determined that the metadata has been updated, the client 100, in block B36, displays a dialogue that prompts the upload of metadata. The client 100 creates, for example a dialogue screen as shown in FIG. 6.

With the above configuration, too, the client 100 can prompt the user to upload metadata. As a result, the client 100 can cause the user to determine whether to upload metadata, thereby uploading metadata to the server 200. Consequently, the operation of uploading metadata can be made simple. Accordingly, it is possible to provide a metadata processing apparatus, a server, a metadata processing method which enable metadata to be shared easily.

For example, after having acquired metadata with the EPG, the client 100 records content. Here, on the basis of the user operation, the client 100 may edit metadata stored before recording the content. Even in such a case, the client 100 can determine in block B35 whether metadata has already been updated. If metadata has not been updated, that is, if metadata remains as the one acquired with the EPG, the client 100 does not display a dialogue that prompts the upload of metadata. If metadata has been updated, that is, if metadata is the one obtained by editing the data acquired with the EPG, the client 100 displays a dialogue that prompts the upload of metadata.

While in the embodiment, the client 100 has been configured to simply display a dialogue screen, it may be configured to further display metadata that requires upload. The client 100 displays a button for determining whether to upload data on a piece of metadata basis, thereby making it much easier for the user to operate.

In addition, the client 100 may be configured to display the dialogue screen for a certain period of time or at specific intervals of time while the upload is not performed instead of displaying, only once, a dialogue screen that prompts the user to upload data. This prevents the user from forgetting upload.

Furthermore, the client 100 may be configured to access the server 200 at specific intervals of time, at a specific time, or at the time when it has been determined that the user has carried out no operation. In this case, the client 100 transmits content identification data to the server 200 at the above described timing and receives from the server 200 data that indicates whether it is necessary to upload metadata. For instance, the client 100 displays a dialogue screen at the time of start-up, at the time when timer recording is performed, or at the time when recorded content is viewed. This prevents the client 100 from operating sluggishly and prompts the user to upload metadata.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising:
a recorder configured to receive content, and to record the received content with data, the data includes basic data and additional data for identifying the content,
an editor configured to enable editing of the additional data in the recorded content,
a display controller configured to perform an indication urged to upload of the additional data if the additional data is edited by the editor,
an upload module configured to upload the edited additional data to server if operation of upload is received,
a transmitter configured to transmit the basic data for identifying the content which played or received, if the content is received, or if the content recorded by the recorder is played,
a download module configured to download the additional data matched with the basic data transmitted by the transmitter from the server which matches and holds the additional data edited by other users and the basic data, and
a recording controller configured to control the recorder to match and record the downloaded additional data on the basic data recorded by the recorder.

2. A data processing method for a data processing apparatus, the metadata processing method comprising:
receiving content, and recording the received content with data on content which includes basic data and additional data for identifying the content,
making it possible to make a user edit the additional data in the recorded the data on content,
performing indication urged to upload of the additional data if the additional data is edited,
uploading the edited additional data to server if operation of upload is received,
transmitting the basic data for identifying the content which played or received, if the content is received, or if the content recorded is played,
downloading the additional data matched with the basic data transmitted from the server which matches and holds the additional data edited by other users and the basic data,
controlling the recording to match and record the downloaded additional data on the basic data recorded.
